(19) United States
(12) Patent Application Publication
(10) Pub. No.: US 2019/0162337 A1
(43) Pub. Date: May 30, 2019

(54) PIPE JOINT

(71) Applicant: FUJIKIN INCORPORATED, Osaka-shi (JP)

(72) Inventors: Keisuke Ishibashi, Osaka-shi (JP); Takayasu Nakahama, Osaka-shi (JP); Toshinori Ochiai, Osaka-shi (JP); Michio Yamaji, Osaka-shi (JP); Tadayuki Yakushijin, Osaka-shi (JP); Takashi Funakoshi, Osaka-shi (JP); Kunihiko Daido, Osaka-shi (JP); Hideyuki Miyagawa, Osaka-shi (JP)

(21) Appl. No.: 16/321,166

(22) PCT Filed: Jul. 25, 2017
(86) PCT No.: PCT/JP2017/026838

§ 371 Date: Jan. 28, 2019

(30) Foreign Application Priority Data
Jul. 29, 2016 (JP) 2016-150488

(51) Int. Cl. F16L 19/02; F16L 23/18; F16L 17/06

(52) U.S. Cl. CPC F16L 19/0218; F16L 23/18; F16J 15/062; F16L 17/06; F16L 19/0206

(57) ABSTRACT

Provided herein is a pipe joint of a relatively small joint diameter for use under ultrahigh pressure conditions. The pipe joint includes first and second joint members having mutually communicating fluid passages; and a gasket interposed between abutting end surfaces of the first and second joint members. The first and second joint members have ring-shaped seal projections formed at the abutting end surfaces thereof. The pipe joint satisfies a coefficient F of 0.4 or less in the following formula (1).

F=(D₃²−D₁²)/(D₄²−D₂²), Formula (1):

where D₁ represents the inner diameter of the first and second joint members, D₂ represents the inner diameter of the gasket, D₃ represents the diameter of the seal projections, and D₄ represents the outer diameter of the gasket.

### TECHNICAL FIELD

The present invention relates to a pipe joint, particularly a pipe joint that forms an area seal by plastic deformation of a gasket.

### BACKGROUND ART

Patent Literature 1 discloses a pipe joint that forms an area seal by plastic deformation of a gasket. The pipe joint includes a first and a second tubular joint member having mutually communicating fluid passages; a circular ring-shaped gasket interposed between the right end surface of the first joint member and the left end surface of the second joint member; and a retainer that holds the circular ring-shaped gasket while being held by the first joint member. The second joint member is fixed to the first joint member with a nut screwed to the first joint member from the second joint member side.

A joint of such a form has high sealing performance, and has successfully been used mainly in the field of semiconductor manufacturing apparatuses.

With the recent development of fuel cell automobiles, there is a demand for a joint for supplying hydrogen under ultrahigh pressure, and joints of various forms have been studied to this end.

Typically, a joint to be used under ultrahigh pressure in the field of fuel cell automobiles must withstand a pressure of 100 MPa or more. Under the High Pressure Gas Safety Act, a joint intended for these applications is required to pass a pressure test under a pressure 1.25 times the pressure used in actual applications.

### CITATION LIST

### Patent Literature

Patent Literature 1: Japanese Patent No. 3876351

### SUMMARY OF INVENTION

### Technical Problem

The pipe joint of the related art involves a leakage problem when used under ultrahigh pressure conditions.

An object of the present invention is to provide a pipe joint suited for use under ultrahigh pressure conditions.

### Solution to Problem

The present invention provides a pipe joint that includes first and second joint members having mutually communicating fluid passages; and a gasket interposed between abutting end surfaces of the first and second joint members, the first and second joint members having ring-shaped seal projections formed at the abutting end surfaces thereof. The pipe joint satisfies a coefficient F of 0.4 or less in the following formula (1).

F=(D₃²−D₁²)/(D₄²−D₂²), Formula (1):

where D₁ represents the inner diameter of the first and second joint members, D₂ represents the inner diameter of the gasket, D₃ represents the diameter of the seal projections, and D₄ represents the outer diameter of the gasket.

The present inventors conducted a finite element analysis with an ultrahigh-pressure fluid flown in the fluid passages inside the first and second joint members, and found that deformation occurring in the gasket influences leak generation. It was also found that advantageous effects can be obtained when an index combining D₁ to D₄ is below a certain value. These findings led to the present invention.

The amounts by which the gasket and the joint members deform are possible factors related to the pressure tightness of the pipe joint.

From observations that a more rigid gasket deforms less under the internal pressure, it can be said that the amount of gasket deformation is dependent on the rigidity of the gasket. Assuming that the gasket thickness is constant, the internal pressure P₁ at which the inner wall of the cylindrical pipe starts to yield can be said as being proportional to (D₄²−D₂²) because P₁ is proportional to the rigidity of the cylindrical pipe.

The joint members deform as the internal pressure is applied to the abutting end surfaces of the joint members, and the amount of deformation can be said as being inversely proportional to the circular ring area defined by the diameter D₃ of the seal projections, and the inner diameter D₁ of the first and second joint members subjected to the pressure of a high-pressure fluid. It can be said from this that the internal pressure P₂ at which the first and second joint members start to yield at their abutting end surfaces is inversely proportional to (D₃²−D₁²).

Because the gasket and the joint members deform simultaneously, the pressure tightness of the gasket can be said as having a negative correlation with coefficient F=(D₃²−D₁²)/(D₄²−D₂²). From a finite element analysis, the preferred value of F was found to be 0.4 or less.

In practice, however, D₁ is subject to restrictions by the pressure and flow rate of the flowing high-pressure fluid, and D₄ is subject to restrictions by the physical size of the pipe joint. Because of these restrictions, a definitive lower limit cannot be set for coefficient F below a certain value in actual practice.

### Advantageous Effects of Invention

A pipe joint applicable to ultrahigh pressure conditions can be provided by adjusting the inner diameter D₁ of the first and second joint members, the inner diameter D₂ of the gasket, the diameter D₃ of the seal projections, and the outer diameter D₄ of the gasket.

### BRIEF DESCRIPTION OF DRAWINGS

FIG. 1 is a longitudinal sectional view representing an embodiment of a pipe point of the invention.

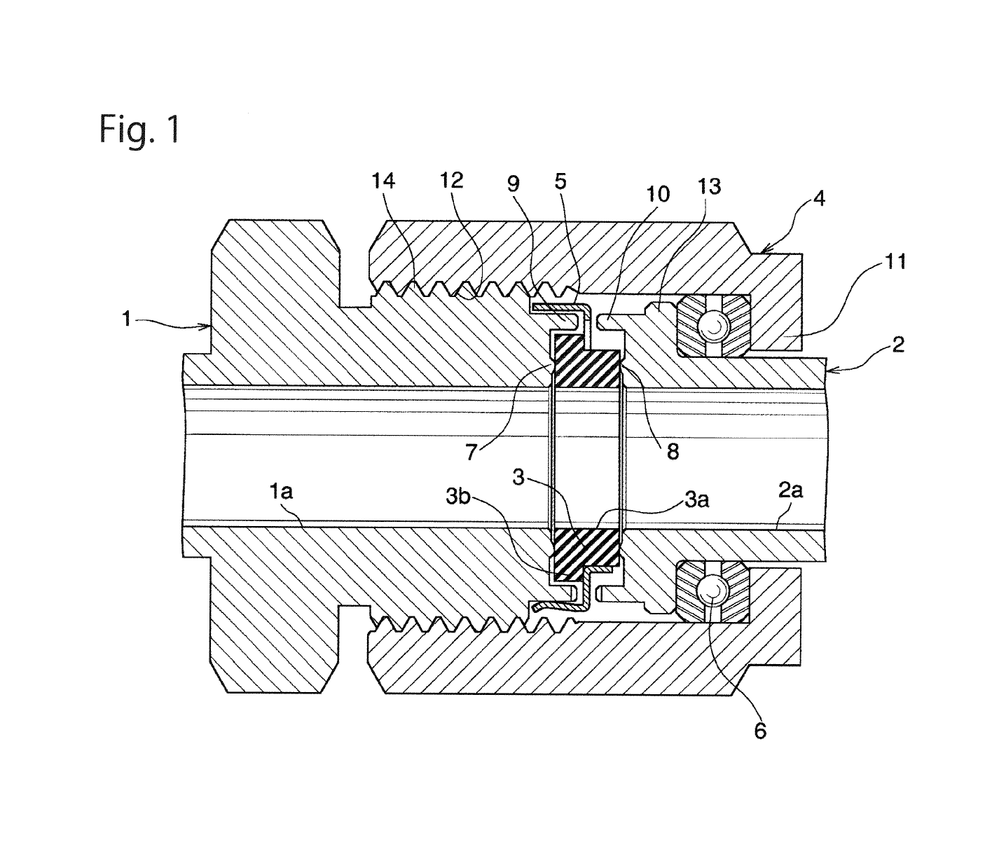

FIG. 2 is a schematic diagram of a model simulating the stress and strain occurring in the pipe joint of FIG. 1 under applied internal pressure.

FIG. 3 is a graph representing a relationship between coefficient F, and the pressure P at which a gasket starts to come off.

FIG. 4 is a graph representing a relationship between coefficient F, and the pressure P at which the contact between a gasket and a joint member becomes loose.

FIG. 5 is a graph representing a relationship between coefficient F, and the gasket displacement at which the contact between a gasket and a joint member becomes loose.

### DESCRIPTION OF EMBODIMENTS

A preferred illustrative embodiment of the present invention is described below in detail, with reference to the accompanying drawings. It is to be noted that the parameters, including the dimensions, materials, shapes, and relative positions of the constituent components described in the embodiment below are merely illustrative, and are not intended to limit the scope of the invention, unless otherwise specifically stated.

A pipe joint includes first tubular joint member (1) and a second tubular joint member (2) having mutually communicating fluid passages; a circular ring-shaped gasket (3) interposed between the right end surface of the first joint member (1) and the left end surface of the second joint member (2); and a retainer (5) that holds the circular ring-shaped gasket (3) while being held by the first joint member (1). The second joint member (2) is fixed to the first joint member (1) with a nut (4) screwed to the first joint member (1) from the second joint member (2) side. The pipe joint also includes circular ring-shaped seal projections (7) and (8) radially formed at the abutting end surfaces of the joint members (1) and (2), and overtightening preventing ring-shaped projections (9) and (10) formed around the seal projections (7) and (8).

The both ends of the gasket (3) are flat surfaces perpendicular to the axial direction. The outer circumferential surface of the gasket (3) has a stopper (3b) composed of an outer flange.

The joint members (1) and (2), and the gasket (3) are made of SUS316L.

An inward flange (11) is formed at a right end portion of the nut (4), and the nut (4) is fitted around the second joint member (2) at the flange (11). The nut (4) has an internal thread (12) formed on the inner circumferential surface of its left end portion, and the internal thread (12) is mated with an external thread (14) formed on the right end portion of the first joint member (1). An outward flange (13) is formed on the outer circumference at the left end of the second joint member (2), and a thrust ball bearing (6) for preventing corotation is interposed between the outward flange (13) and the inward flange (11) of the nut (4).

The overtightening preventing ring-shaped projections (9) and (10) project further toward the gasket (3) in horizontal direction than the circular ring-shaped seal projections (7) and (8), so that the projections (9) and (10) press the retainer (5) from both sides when the joint members are tightened with a force that exceeds the proper torque.

The gap between the retainer (5) and the overtightening preventing projections (9) and (10) reaches zero as the nut (4) is tightened with a tool such as a spanner after it is fitted in place by hand, and further tightening of the nut (4) is met with greatly increasing resistance to prevent overtightening.

The inner circumference (1a) of the first joint member (1), the inner circumference (2a) of the second joint member (2), and the inner circumference (3a) of the gasket form a fluid passage.

When the inner diameter of the first and second joint members is D₁, the inner diameter of the gasket is D₂, the diameter of the seal projections is D₃, and the outer diameter of the gasket is D₄, it is preferable that the coefficient F=(D₃²−D₁²)/(D₄²−D₂²) be 0.4 or less. The coefficient F is more preferably 0.3 or less.

Here, D₃ is the diameter of the ring as measured at the center of the highest portion of the circular ring-shaped seal projections (7) and (8), and D₄ is the outer diameter of the circular ring-shaped gasket (3), excluding the stopper (3b).

With a coefficient F of 0.4 or less, the gasket tends to deform less. A coefficient F of 0.3 or less is even more preferred because the gasket deforms even less with such a coefficient F.

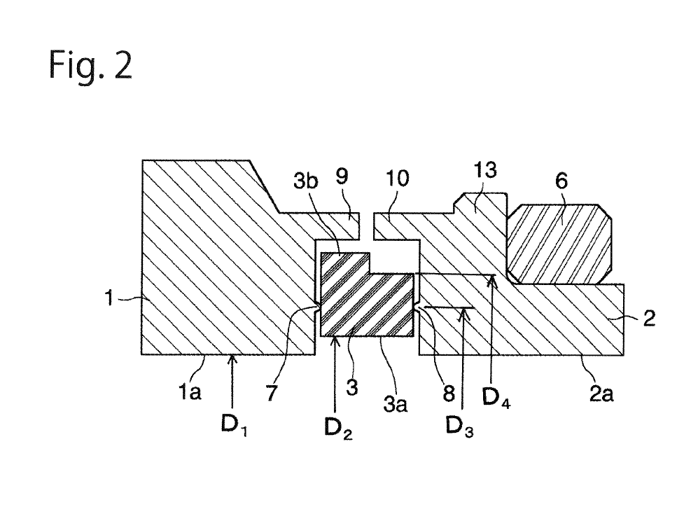

FIG. 2 is a schematic diagram representing a model simulating the stress and strain occurring in the pipe joint under applied internal pressure. The basic configuration analyzed had the gasket (3) between the first pipe joint (1) and the second pipe joint (2). D₁ is the inner diameter at the circumference (1a, 2a), D₂ is the inner diameter at the circumference (3a), D₃ is the diameter of the circular ring-shaped seal projection (7, 8), and D₄ is the outer diameter of the gasket (3) excluding the stopper (3b).

### TEST EXAMPLE 1

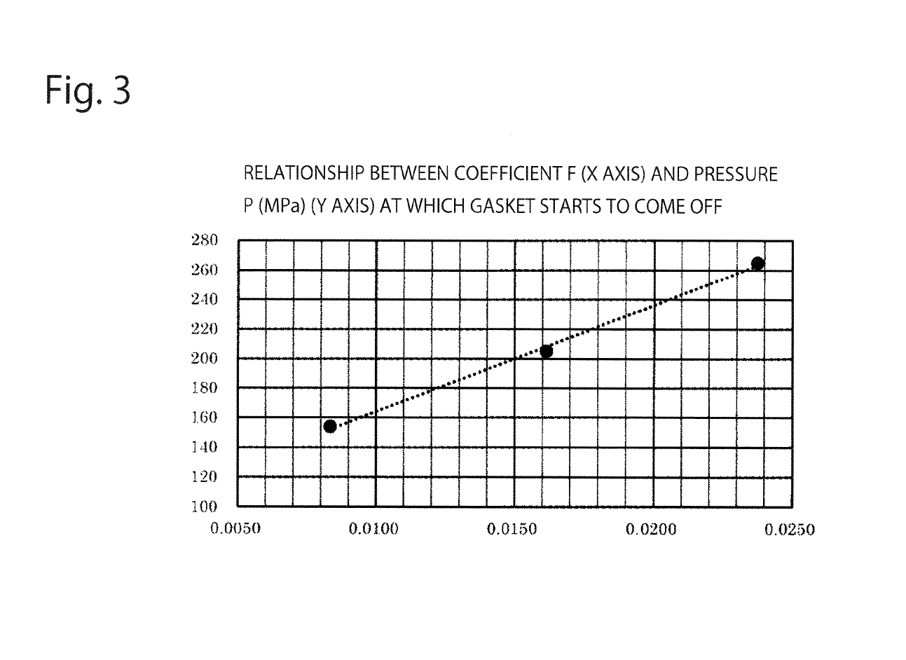

A finite element analysis was conducted using members made of stainless steel. Table 1 below shows values of D₁ to D₄, coefficients F derived from these values of D₁ to D₄, and pressures P at which the gasket (3) starts to come loose. FIG. 3 is a graph representing a relationship between F and P. The broken line represents an approximate straight line.

TABLE 1

| | | | | | | Pressure P at |
|---|---|---|---|---|---|---|
| | | | | | | which gasket |
| Analysis | D₁ | D₂ | D₃ | D₄ | Coefficient | starts to come |
| No. | (mm) | (mm) | (mm) | (mm) | F | loose (MPa) |
| Analysis 1 | 4.35 | 7.57 | 9.00 | 10.90 | 1.0093 | 153.72 |
| Analysis 2 | 3.30 | 4.40 | 5.80 | 10.2 | 0.2686 | 264.96 |
| Analysis 3 | 5.50 | 6.00 | 9.00 | 14.10 | 0.3117 | 205.20 |

As can be seen from FIG. 3, the coefficient F is linearly related to the pressure P at which the gasket starts to come off, showing that the coefficient F is indeed appropriate.

### TEST EXAMPLE 2

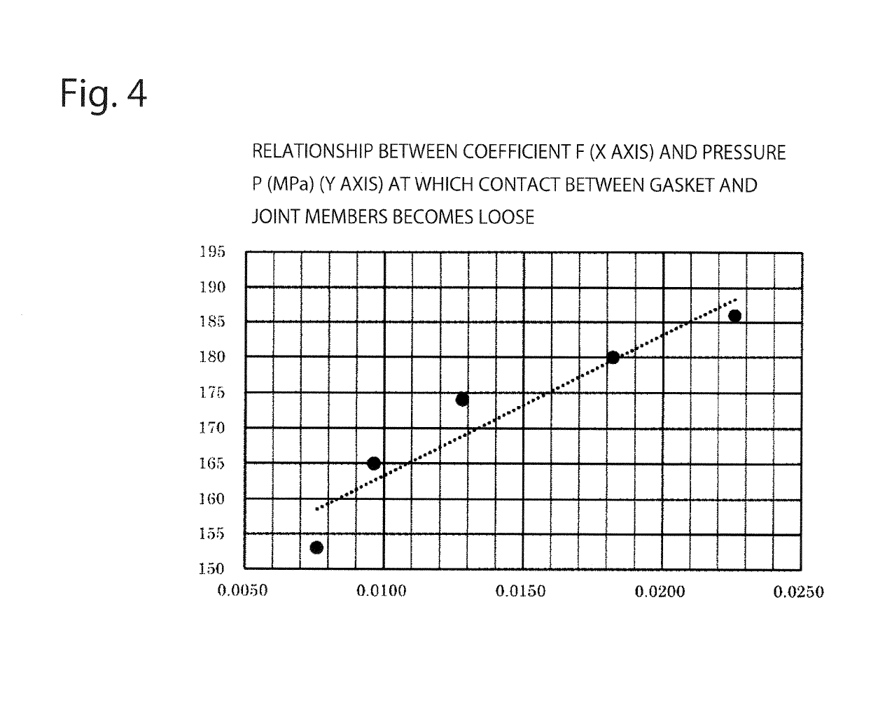

A finite element analysis was conducted using members made of stainless steel. Table 2 below shows values of D₁ to D₄, coefficients F derived from these values of D₁ to D₄, and pressures P at which the contact between the gasket (3) and the joint members (1) and (2) becomes loose. FIG. 4 is a graph representing a relationship between F and P. The broken line represents an approximate straight line.

TABLE 2

| | | | | | | Pressure P at |
|---|---|---|---|---|---|---|
| | | | | | | which contact |
| Analysis | D₁ | D₂ | D₃ | D₄ | Coefficient | starts to become |
| No. | (mm) | (mm) | (mm) | (mm) | F | loose (MPa) |
| Analysis 4 | 6.00 | 6.00 | 12.00 | 14.10 | 0.6633 | 153.00 |
| Analysis 5 | 6.00 | 6.00 | 11.00 | 14.10 | 0.5221 | 165.00 |
| Analysis 6 | 6.00 | 6.00 | 10.00 | 14.10 | 0.3931 | 174.00 |
| Analysis 7 | 6.00 | 6.00 | 9.00 | 14.10 | 0.2764 | 180.00 |
| Analysis 8 | 6.00 | 6.00 | 8.50 | 14.10 | 0.2227 | 186.00 |

As can be seen from FIG. 4, strong linearity is maintained between coefficient F and the pressure P at which the contact starts to become loose, as in FIG. 3, though the approximate straight line is less steep than in FIG. 3 because the test analyzes the pressure at which the gasket and the joint members start to lose contact. It can be understood from this result that the coefficient F is appropriate.

### TEST EXAMPLE 3

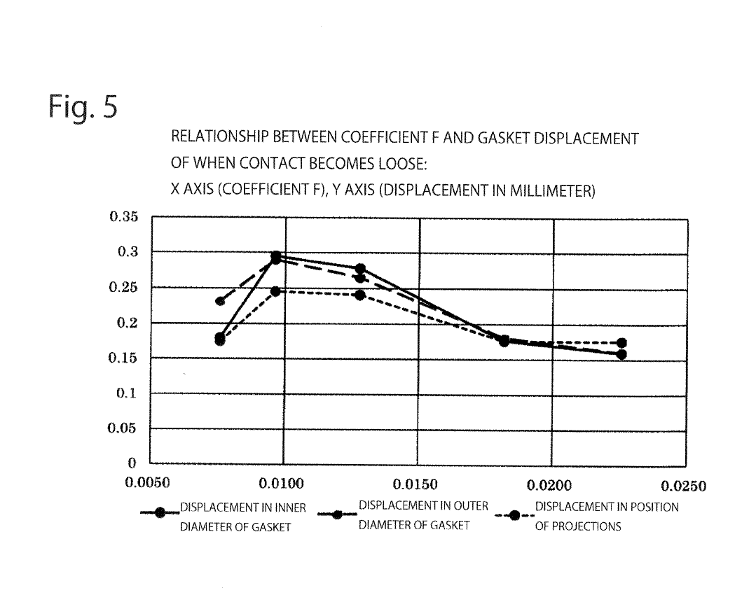

A finite element analysis was conducted under the same conditions used in Test Example 2. Table 3 below shows values of D₁ to D₄, and coefficients F derived from these values of D₁ to D₄, along with the displacements in the inner and outer diameters of the gasket, and the displacement in the circular ring-shaped seal projections (7) and (8) by the gasket as measured when the contact between the gasket (3) and the joint members (1) and (2) was lost. FIG. 5 is a graph representing a relationship between F and displacement. The unit of displacement is millimeter.

TABLE 3

| | | | | | | Displacement in | Displacement in | Displacement of |
|---|---|---|---|---|---|---|---|---|
| Analysis | D₁ | D₂ | D₃ | D₄ | Coefficient | inner diameter | outer diameter | ring-shaped |
| No. | (mm) | (mm) | (mm) | (mm) | F | of gasket | of gasket | seal projection |
| Analysis 9 | 6.00 | 6.00 | 12.00 | 14.10 | 0.6633 | 0.180 | 0.232 | 0.175 |
| Analysis 10 | 6.00 | 6.00 | 11.00 | 14.10 | 0.5221 | 0.295 | 0.290 | 0.245 |
| Analysis 11 | 6.00 | 6.00 | 10.00 | 14.10 | 0.3931 | 0.278 | 0.265 | 0.241 |
| Analysis 12 | 6.00 | 6.00 | 9.00 | 14.10 | 0.2764 | 0.177 | 0.181 | 0.176 |
| Analysis 13 | 6.00 | 6.00 | 8.50 | 14.10 | 0.2227 | 0.159 | 0.160 | 0.176 |

In FIG. 5, the displacement in the inner diameter of the gasket is represented by solid line, the displacement in the outer diameter of the gasket is represented by broken line, and the displacement in the position of the circular ring-shaped seal projection of the gasket is represented by dotted line. Ina range of coefficient Fbetween 0.66 and 0.52, all of these displacements increase as the coefficient F decreases. In a range of coefficient F between 0.52 and 0.40, all of the displacements are almost constant, regardless of the coefficient F. In a range of coefficient F between 0.40 and 0.27, all of the displacements decrease as the coefficient F decreases. The displacements are the smallest, and remain constant in a range of coefficient F of 0.27 or less.

Because smaller displacements are more advantageous in terms of improving pressure tightness, the coefficient F is preferably in a range of 0.4 or less, in which the displacements are smaller. More preferably, the coefficient F is in a range of 0.3 or less, in which the displacements have the smallest values, and remain constant.

### INDUSTRIAL APPLICABILITY

A pipe joint can be provided that is compact, and is optimally shaped for use in a pipe intended for use under ultrahigh pressure.

### REFERENCE SIGNS LIST

1: First joint member
2: Second joint member
3: Gasket
7: Circular ring-shaped seal projection
8: Circular ring-shaped seal projection

1. A pipe joint comprising:
first and second joint members having mutually communicating fluid passages; and
a gasket interposed between abutting end surfaces of the first and second joint members,
the first and second joint members having ring-shaped seal projections formed at the abutting end surfaces thereof,
wherein the pipe joint satisfies a coefficient F of 0.4 or less in the following formula (1),
F=(D₃²−D₁²)/(D₄²−D₂²), Formula (1):
where D₁ represents the inner diameter of the first and second joint members, D₂ represents the inner diameter of the gasket, D₃ represents the diameter of the seal projections, and D₄ represents the outer diameter of the gasket.
